(19) United States
(12) Patent Application Publication
(10) Pub. No.: US 2001/0054012 A1
(43) Pub. Date: Dec. 20, 2001

(54) Client-based shopping cart

(75) Inventor: Arjun Nayyar, Los Angeles, CA (US)

Correspondence Address: Anna M. Vradenburgh, Brull Piccionelli Sarno Braun & Vradenburgh, Suite 2350, 1925 Century Park East, Los Angeles, CA, 90067, US

(73) Assignee: Wildform, Inc.

(21) Appl. No.: 09/880,570

(22) Filed: Jun. 13, 2001

Related U.S. Application Data
(60) Provisional application No. 60/212,064, filed on Jun. 14, 2000.

(51) Int. Cl. G06F 17/60

(52) U.S. Cl. 705/26; 705/27

(57) ABSTRACT

A method for carrying out a transaction between a client and a server in an electronic marketplace hosted by the server is provided. Data from a server is provided to a client sufficient to enable the client to operate a client-based shopping cart in an electronic marketplace hosted by the server. The client-based shopping cart is activated, and an item is added to the client-based shopping cart. Information necessary to complete a transaction for the item is calculated using the client-based shopping cart. A transaction for the item is then submitted to the server together with the calculated information, and the transaction is processed using the server.

This application is based on U.S. Provisional Patent Application Serial No. 60/212,064, filed Jun. 14, 2000, the disclosure of which is incorporated in its entirety herein by reference.

### FIELD OF THE INVENTION

The present invention relates to computer-based selection of items and shopping across a network between a client station and a server station. Specifically, the invention relates to the use of client side processing whereby the client processes all functions related to the maintenance, display, interaction, and processing of the shopping cart.

### BACKGROUND OF THE INVENTION

Typical shopping cart systems employed on computer networks, such as the Internet, rely on constant communication with the database or file based server hosting the shopping cart system. Every action performed in relation to the shopping cart requires the client browser to submit an action request to the server. The server processes the request and returns a file reflecting the updated state of the shopping cart to the client browser. Usually, the state is kept between requests through the use of hidden fields present on every request, through the use of client side cookies containing identifiers, or through other types of persistence between request mechanisms.

In many cases, the delays associated with repeated requests to the server and the delays associated with rendering updated shopping cart pages result in a lower perceived quality of service and lower perceived performance to customers using online shopping cart systems. In addition, research indicates that a large percentage of customers conducting transactions through computer based shopping carts abandon the process before completing a transaction because it takes too much time, mostly due to the delays of repeated communication with the hosting server and repeated page redraws. The repeated requests to the server are impractical for low bandwidth connections such as analog modems, low speed digital lines, and wireless network connections. Finally, greater resources are required by the hosting server to respond to the repeated requests by the client, including building updated shopping cart pages and updating the server side store of the cart's current contents.

A need exists for an improved shopping cart that reduces processing time.

### SUMMARY OF THE DISCLOSURE

In accordance with one aspect of the present invention, there is provided a method for carrying out a transaction between a client and a server in an electronic marketplace hosted by the server. The method includes the steps of: providing data from a server to a client sufficient to enable the client to operate a client-based shopping cart in an electronic marketplace hosted by the server; activating the client-based shopping cart; adding an item to the client-based shopping cart; calculating information necessary to complete a transaction for the item using the client-based shopping cart; submitting a transaction for the item to the server together with the calculated information; and processing the transaction using the server.

In particular embodiments, the client-based shopping cart is activated by selection of an item to be placed in the client-based shopping cart.

In other particular embodiments, the client-based shopping cart stores data provided by the server and pertaining to the item when the item is added to the client-based shopping cart. The client-based shopping cart then uses the stored data to calculate the information necessary to complete the transaction for the item.

In accordance with another aspect of the present invention, there is provided a method for carrying out a transaction between a client and a server in an electronic marketplace hosted by the server that includes the steps of: entering an electronic marketplace hosted by a server by means of a client-based browser; providing data from the server to the client sufficient to enable the client to operate a client-based shopping cart in the electronic marketplace hosted by the server; activating the client-based shopping cart; adding an item to the client-based shopping cart; calculating information necessary to complete a transaction for the item using the client-based shopping cart; submitting a transaction for the item to the server together with the calculated information; and processing the transaction using the server.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is an illustration of a client computer connected to a server computer connected over a computer network, such as the Internet.

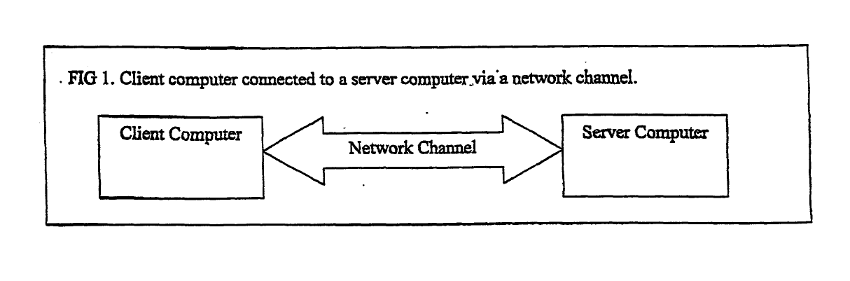

FIG. 2 is a flow diagram illustrating the operation of an embodiment of the invention

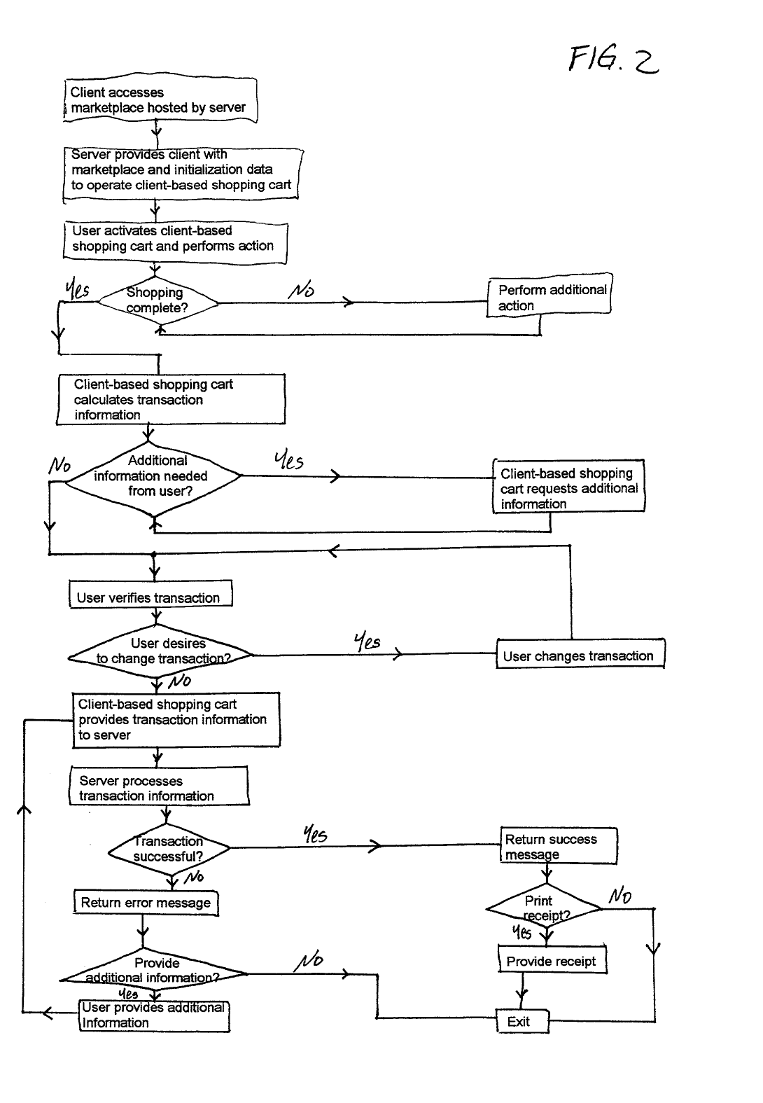

### DETAILED DESCRIPTION OF THE PREFERRED EMBODIMENT

A method and apparatus for a client-based shopping cart are presented that solve the problems associated with prior shopping carts. The method of the present invention processes all shopping cart operations on the client side. The final authorization for the shopping transaction is performed via a network connection to a transaction authorization server.

Rather than submitting a request to the server for each shopping cart action, such as adding an item to the cart, removing an item from the cart, updating the quantities of items in the cart, and collecting fulfillment and delivery information and other information related to the transaction, all transaction information is collected, maintained, and processed by the client system. After the client-side shopping cart has collected all required information, the cart system submits a transaction authorization request to a transaction authorization server. The request contains all information required to complete the transaction and deliver the items purchased in the transaction. The transaction request “package” contains all required data collected in the client-side shopping cart.

If errors occur in any stage of the shopping process, the client-side shopping cart is capable of correcting such process errors. The client-side shopping cart is also capable of generating error messages for display without the assistance of the hosting server. If the final authorization transaction fails, the client-side shopping cart displays the state of the transaction and allows the user to modify the information in the shopping cart for resubmission without intervention from the hosting server.

In the following description, for purposes of explanation, numerous specific details are set forth in order to provide a thorough understanding of the present invention. It will be evident, however, to one skilled in the art that the present invention may be practiced without these specific details. In other instances, well-known structures and devices are shown in block diagram form in order to facilitate description of the present invention.

In one embodiment, steps according to the present invention are embodied in machine-executable software instructions, and the present invention is carried out in a processing system by a processor executing the instructions, as will be described in greater detail below. In other embodiments, hardwired circuitry may be used in place of, or in combination with, software instructions to implement the present invention.

The present invention relates in one embodiment to a system in which a client computer system is connected to a server computer system over a communications network such as the Internet, local area networks, or wireless communications networks. The client computer enters an electronic marketplace hosted on the server computer systems, for example through the use of a client-based browser. The server returns instructions describing the rules, options, and items available through the marketplace to the client computer in a machine-readable form. Information describing discrete items in the marketplace can also be sent to the client. The client computer renders the information and enforces the rules of the electronic marketplace, such as the ability to select specific items. As the client computer is instructed to navigate through the options and items available in the marketplace, the client computer can make requests to the server for more information.

The client-based shopping cart is activated once the user selects an item to add to the shopping cart, or once an action related to the shopping cart is performed. In addition, the shopping cart can be activated as a first step in entering the marketplace via the client browser if the maintainer of the marketplace or user of the client browser chooses. Reasons for activating the shopping cart immediately upon entering could include, without limitation, authentication or population of the shopping cart with items the user of the browser may have selected in a previous session. The shopping cart can also be configured to support multiple marketplaces, allowing one shopping cart to maintain items for final authorization by a single or multiple transaction authorization servers for a multitude of marketplaces. In that case, the cart is initialized when the client browser enters the group of marketplaces. The shopping cart=s initialization can include setting variables that store an authentication token, other identifying tokens, rules for the operation of the cart, and the rules of the marketplace such as taxes to be applied to totals and other ancillary charges, and information required for the operation of the cart.

When a client selects an item to add to the client-based shopping cart, the client browser instructs the client-based shopping cart to store information related to the item, such as an identifying product code, the quantities associated with the item, and/or the cost of the item. The client-based shopping cart uses the stored information to calculate total costs, total quantity of items, and other information required for display or processing. Other actions, such as modifying the quantity of an item in the shopping cart, removing an item, and the like, are performed by the client browser instructing the shopping cart to conduct the requested actions. The actions are performed inside the shopping cart via stored variables and defined rules.

Once the client browser has completed navigating the marketplace and chooses to complete the transaction, the client-based shopping cart can request additional information from the client in order to satisfy the information requirements for completion of the transaction. Additional information can include, without limitation, the address for delivery of the selected item(s), credit card authorization information, the calculation of taxes if any, and any other information required for the current transaction. The shopping cart can already have access to this information in particular embodiments in which the server computer provides the information during the shopping cart's initialization or in which the client browser's user provided the information before choosing to complete the transaction. If the shopping cart already contains all required information, the cart can display the information and allow the client browser to verify, and if necessary modify, the stored information.

After all the information required to complete the transaction has been collected and verified, the client browser is presented with the option of submitting the transaction for authorization. Upon the request for submission of the transaction via the client browser, the information required by the transaction authorization server is complied into a form in which the server expects to receive the information. The transaction information can be compiled, for example, as name-value pairs, XML data, another tagged data format, EDI format, comma-separated values, or any other data format compatible with the transaction server. The compiled data is submitted to the transaction server via a non-secure or secure channel, after which the client waits for a response from the server. While the shopping cart is waiting for a reply from the authorization server, it can perform other actions. For example, the shopping cart can inform the client browser of its current state or the state of the transaction, or occupy the user in some fashion.

Once the shopping cart receives a response from the server, the client preferably displays the results of the operation. If the transaction is declined, the shopping cart can offer the user an opportunity to modify the information submitted to the authorization server and resubmit the request. Otherwise, if the transaction is approved, the shopping cart can display the results of the operation and provide further information or options, such as creating a receipt for printing, or the option to uninitialize the shopping cart and leave the electronic marketplace.

The present invention thus provides a mechanism for conducting commerce across a computer network without support from or access to a server to maintain state, perform operations, or display a shopping cart metaphor electronically.

While the invention has been particularly shown and described with reference to a preferred embodiment thereof, it will be understood by those skilled in the art that various other changes in the form and details may be made therein without departing from the spirit and scope of the invention.

What is claimed is:

1. A method for carrying out a transaction between a client and a server in an electronic marketplace hosted by the server, the method comprising the steps of:
i) providing data from a server to a client sufficient to enable the client to operate a client-based shopping cart in an electronic marketplace hosted by the server,
ii) activating the client-based shopping cart,
iii) adding an item to the client-based shopping cart,
iv) calculating information necessary to complete a transaction for the item using the client-based shopping cart,
v) submitting a transaction for the item to the server together with the calculated information, and
vi) processing the transaction using the server.

2. The method of claim 1 wherein in step (ii) the client-based shopping cart is activated by selection of an item to be placed in the client-based shopping cart.

3. The method of claim 1 wherein in step (iii) the client-based shopping cart stores data provided by the server and pertaining to the item when the item is added to the client-based shopping cart, and wherein in step (iv) the client-based shopping cart uses the stored data to calculate the information necessary to complete the transaction for the item.

4. The method of claim 1 wherein prior to step (v) additional information required to complete the transaction is provided by a user of the client.

5. The method of claim 1 wherein prior to step (v) additional information required to complete the transaction is provided by the server.

6. The method of claim 1 wherein in step (vi) the server determines whether the transaction is successfully completed.

7. The method of claim 6 wherein in step (vi) the server determines that the transaction is successfully completed and returns a success message to the client.

8. The method of claim 6 wherein in step (vi) the server determines that the transaction is not successfully completed and requests additional information from the client pertaining to the transaction.

9. The method of claim 6 wherein in step (vi) the server determines that the transaction is not successfully completed and requests modified information from the client pertaining to the transaction.

10. A method for carrying out a transaction between a client and a server in an electronic marketplace hosted by the server, the method comprising the steps of:
i) entering an electronic marketplace hosted by a server by means of a client-based browser,
ii) providing data from the server to the client sufficient to enable the client to operate a client-based shopping cart in the electronic marketplace hosted by the server,
iii) activating the client-based shopping cart,
iv) adding an item to the client-based shopping cart,
v) calculating information necessary to complete a transaction for the item using the client-based shopping cart,
vi) submitting a transaction for the item to the server together with the calculated information, and
vii) processing the transaction using the server.

11. The method of claim 10 wherein step (ii) is carried out simultaneously with step (i).

12. The method of claim 10 wherein steps (i), (ii) and (iii) are carried out simultaneously.

13. The method of claim 10 wherein in step (i) a plurality of electronic marketplaces are entered and wherein in step (ii) the client-based shopping cart is enabled to operate in each of the electronic marketplaces.

14. The method of claim 10 wherein in step (ii) the server provides the client with data concerning at least one pre-selected item for placement within the client-based shopping cart.

15. The method of claim 10 wherein in step (iv) a plurality of items are added to the clientbased shopping cart.

16. The method of claim 15 which includes the step of removing at least one item from the client-based shopping cart prior to step (v).

17. The method of claim 10 wherein in step (iv) the client-based shopping cart stores data provided by the server and pertaining to the item when the item is added to the client-based shopping cart, and wherein in step (iv) the client-based shopping cart uses the stored data to calculate the information necessary to complete the transaction for the item.

18. The method of claim 10 wherein prior to step (vi) additional information required to complete the transaction is provided by a user of the client.

19. The method of claim 10 wherein prior to step (vi) additional information required to complete the transaction is provided by the server.

20. The method of claim 10 wherein in step (vii) the server determines whether the transaction is successfully completed.

21. The method of claim 20 wherein in step (vii) the server determines that the transaction is successfully completed and returns a success message to the client.

22. The method of claim 20 wherein in step (vii) the server determines that the transaction is not successfully completed and requests additional information from the client pertaining to the transaction.

23. The method of claim 20 wherein in step (vii) the server determines that the transaction is not successfully completed and requests modified information from the client pertaining to the transaction.
